(19) United States
(12) Patent Application Publication
(10) Pub. No.: US 2014/0076164 A1
(43) Pub. Date: Mar. 20, 2014

(54) ADSORPTION PURIFICATION UNIT WITH ROTARY DISTRIBUTOR AND MEANS FOR REGULATING THE FLOW RATES

(71) Applicants: Christian Monereau, Montpellier (FR); Bernard Saulnier, La Garenne Colombes (FR)

(72) Inventors: Christian Monereau, Montpellier (FR); Bernard Saulnier, La Garenne Colombes (FR)

(73) Assignee: L'Air Liquide Société Anonyme pour I'Exploitation des Procédés Georges Claude, Paris (FR)

(21) Appl. No.: 14/115,633

(22) PCT Filed: Apr. 20, 2012
(86) PCT No.: PCT/FR2012/050862

§ 371 Date: Nov. 5, 2013

(30) Foreign Application Priority Data
May 9, 2011 (FR) 1153961

(51) Int. Cl. B01D 53/04; B01D 53/047

(52) U.S. Cl. CPC B01D 53/0446; B01D 53/047
USPC 96/109; 96/124; 96/115; 96/116

(57) ABSTRACT

Pressure swing adsorption purification unit (PSA unit) comprising:
N adsorbers comprising N inlets and N outlets with N≧2;
at least one rotary distributor connected via N connections to the N inlets or to the N outlets of the N adsorbers; and
   characterised in that each of these N connections comprises a means for regulating a flow rate.

### CROSS REFERENCE TO RELATED APPLICATIONS

This application is a 371 of International PCT Application PCT/FR2012/050862, filed Apr. 20, 2012, which claims priority to French Application 1153961, filed May 9, 2011, the entire contents of which are incorporated herein by reference.

### BACKGROUND

This invention relates to a pressure swing adsorption purification unit (PSA unit) and in particular to a PSA unit calling into play a cycle of short duration.

Cycle time (Tc) means the time that an adsorber takes to go through the complete adsorption and regeneration cycle and to return to its initial state. Note that for a PSA unit comprising N adsorbers working in an offset manner, the phase time Tph is generally defined by Tc/N. A phase time can include one or several steps (for example, 2 successive pressure equalisations) or inversely one step can correspond to several phase times (for example, the adsorption step can extend over 3 phase times).

A first trend is to reduce the cycle time of the PSAs in order to “make the adsorbent work faster” and as such reduce the size of the adsorbers and, through this, investment. This type of unit is habitually referred to as RPSA (Rapid PSA). In order to limit load losses, improve the kinetics and prevent the putting into movement of particles, contactors shall preferably be used, i.e. adsorbers comprising structured adsorbents (for example the adsorbent is deposited as a thin layer on a support which is then rolled).

Another trend was to use more complex PSA cycles, calling for example into play several pressure equalisations, with several adsorbers simultaneously in production and/or in elution. The purpose in this case is generally to increase the performance of the separation unit, as for example to increase the extraction efficiency of the product or decrease the energy consumed.

In these two cases, using conventional valves, which make it possible to direct the various flows towards the correct adsorbers and with the correct quantities, becomes difficult and even problematic.

For the most complex cycles, around a hundred valves can be reached leading to obvious problems concerning reliability and maintenance.

For the fastest cycles, the manoeuvring times required (fraction of seconds) are such that only small very specific valves can still partially respond to these constraints.

It is known that for these reasons a good solution can consist in using multi-channel rotary distributors. Rotary distributor means a system that is able to successively place circuits into contact by the means of fixed orifices on a stator and mobile orifices on a rotor. The fixed orifices are generally connected to an end of an adsorber. The rotor in this case is in relation with the supply and residual gas circuit. A second distributor will preferably be used of which the stator will be connected to the second end of the adsorber and the rotor to the production circuit.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 diagrammatically shows an RPSA with 6 adsorbers and comprising 2 rotary distributors.

The rotary distributor 7 makes it possible to successively supply the 6 adsorbers 1, 2, 3, 4, 5 and 6 with gas to be purified 70.

It also allows for the flow of the residual gas 72 loaded with impurities.

In an identical manner, the rotary distributor 8 makes it possible to remove the production 71 and to carry out the steps of equalisation and of the supply of elution gas by putting adsorbers at different pressures into relation.

The fluids flow between adsorbers and rotary distributors by the means of respective connections 10 to 60 on the one hand and 11 to 61 on the other hand.

FIG. 2 shows the principle for opening and closing circuits.

### DESCRIPTION OF PREFERRED EMBODIMENTS

Placing the openings facing one another successively defines a plurality of flow path for gaseous fluids.

The openings of the rotor 1, shown here in a plane, pass in front of the orifices of the stator connected via a connection to the corresponding adsorber.

If it is supposed that this is the rotary distributor on the purified gas side, then the production of the adsorber 10 is evacuated through the orifice 10 of the stator and the orifice a of the rotor as long as the 2 orifices are at least partially covered.

The adsorbers 20 and 50 are in pressure equalisation via 20, b, the circuit be of the rotor which connects these 2 orifices, e and 50.

The adsorber 30 provides elution gas to the adsorber 40 via 30, c, cd, d and 40.

The rotary distributors can rotate in a discontinuous manner (in steps) or continuously. Preferentially, the rotation is continuous.

As the openings are fixed dimensionally (openings in the rotor and stator), a distributor in itself does not offer means for regulating of the type of that of conventional valves of which the opening can be regulated (needle, butterfly, valve, etc.).

However, in PSA cycles, it is very frequently required to adapt the internal flow rates, as for example in the case where the cycle time is not at its nominal value (reduced flow rate, change in the purity of the product, etc.). Many patents cover the regulating of the steps of PSAs, in particular according to the duration of the steps.

The only parameter whereon it is easy to intervene is the speed of rotation which makes it possible to modify the open time of the circuits.

The speed variation alone does not make it possible to optimally maintain most of the PSA cycles as shall be shown hereinbelow.

In order to explain this point, we shall take the example of a simple cycle with a production phase (a) at the adsorption pressure Pads, a phase of pressure equalisation between adsorbers via their “product” ends (b), a phase of producing elution gas (c), a phase of final decompression with counter-current flow to the low cycle pressure Preg (d), a phase of elution (e), a pressure equalisation phase (f) corresponding to the step (b) and finally a step of final recompression with the product (g).

The corresponding pressure cycle is that shown in FIG. 3.

As it is desired in this cycle to house the steps of equalisation (f) and of final recompression (g) in the same phase, the duration of the equalisation (f) is for example equal to half of one phase. As this is simultaneous, the corresponding equalisation on the depressurisation side (b) is also equal to the phase time divided by 2. The rest of the phase then corresponds to an idle time I (Idle).

The cut-off pressure Pint between the phase of producing elution gas (c) and the phase of final decompression is very important in obtaining optimum performance of the PSA.

Excessive pressure results in a decrease in elution gas which is no longer sufficient to suitably regenerate the adsorbent and inversely, insufficient pressure corresponds to an excessive amount of gas withdrawn by the production end driving the impurities too far towards the production end.

The cycle is carried out using 2 rotary distributors mounted on the same axis rotating at 100% of its speed.

The orifices of the stators and rotors were calculated and possibly adjusted in order to obtain the pressure cycle shown in FIG. 3.

Now suppose that it is required to operate at a reduced flow rate for any reason whatsoever, supposing at 50%.

In order to treat the same quantity of gas—and stop the same quantity of impurities—, the 50% of the supply flow rate must be sent for twice as much time.

The rotating speed of the distributors shall therefore be reduced as a first approximation to 50%.

The pressure cycle of FIG. 4 is obtained.

Without restriction on the gas circuit, the equalisation between adsorbers will take place in the same time as previously. During the remaining time, with the adsorbers at the same pressure, there is no longer anything happening. A substantial idle time I′ is obtained, here equal to 3 I. For most PSA cycles (PSA H2, PSA CO2, etc.), this is not a problem.

However, with a double duration, the step of producing elution gas (c′) will continue beyond the optimum pressure Pint causing as mentioned hereinabove the rising of impurities in the adsorber. The final depressurisation (d′) will therefore be limited and complete even before half of the planned duration. The step of elution will be carried out with a gas excess that is much more impure than in the nominal case. The equalisation that follows (f′) will take place as quickly as at the 100% flow rate, which does not give rise to any particular problem. The final repressurisation step will take place at first approximation in the same time as for a nominal cycle. The flow rate sampled will be identical to the 100% case but it will be sampled now over half of a flow rate. In most cases this results in a collapse of the adsorption pressure with as a consequence a production flow rate that is highly irregular, or even temporarily interrupted, as shown on the diagram (a′).

On the other hand, the pressure drop in the middle of the production step is not favourable to the performance of the PSA as it results in a partial desorption of the impurities.

A solution in order to prevent these disadvantages consists in using particular cycles, in adding capacities, etc. This complicates the unit and the distributor which then must put the adsorbers and these capacities into relation cyclically.

The gas can be “removed” from the distributor, a member for regulating installed and the gas put back into the distributor. This substantially complicates the rotary distributor. FIG. 5 diagrammatically shows the type of modification that this could involve. In order to put the adsorbers 20 and 50 into relation, instead of taking the path 20, e, b-e, e and 50, the carriage e-j must be used up to the crown of outlet j, exit via the opening 70, pass through an outside circuit comprising a means for regulating the flow rate 75, return via the orifice 80 of the stator, pass through the crown k and return to the orifice b of the rotor via the carriage b-k, before passing back through the orifice 50 of the stator in order to reach the adsorber 50. The size of the distributor, of the friction surfaces, the number of seals to be carried out, etc. are increased.

EP 1 340 531 overcomes this problem by rendering the rotary distributors sophisticated when then include incorporated means for regulating.

This increased complexity makes the distributors less reliable and much more difficult to carry out.

Starting from this, one problem that arises is to provide an improved adsorption purification unit in such a way that an adaptation of the internal flow rates is possible while still retaining standard rotary distributors.

A solution of this invention is a pressure swing adsorption purification unit (PSA unit) comprising:
N adsorbers comprising N inlets and N outlets with N≧2;
at least one rotary distributor connected via N connections to the N inlets or to the N outlets of the N adsorbers; and

characterised in that each of these N connections comprises a means for regulating a flow rate.

Note that PSA or RPSA means the adsorption cycles that implement a phase of adsorption of the gas or gases that are the most adsorbable at high pressure and with a regeneration taking place mainly by via a drop in pressure. The regeneration pressure can be under, over or in the vicinity of atmospheric pressure. The term “PSA” thus covers the units which can moreover be named PSA, VSA, PVSA or MPSA.

According to an alternative, the purification unit according to the invention can include a first rotary distributor connected via N first connections to the N inlets of the N adsorbers and a second rotary distributor connected via N second connections to the N outlets of the N adsorbers; each of the N first connections and/or of the N second connections comprising a means for regulating a flow rate.

The first rotary distributor and the second rotary distributor are more preferably mounted on the same axis. Indeed, as the two distributors are operating in a synchronised manner, it is normal that they be mounted on a single axis driven by a single motor.

According to the case, the purification unit according to the invention can include one or several of the following characteristics:
at least one rotary distributor is a distributor with continuous or discontinuous rotation; if 2 rotary distributors (the first rotary distributor and the second rotary distributor) are used, each of the rotary distributors is preferably a distributor with continuous or discontinuous rotation;
at least one rotary distributor has a variable speed; if 2 rotary distributors (the first rotary distributor and the second rotary distributor) are used, each of the rotary distributors is preferably with a variable speed;
said unit comprises from 2 to 30 adsorbers, preferably from 6 to 20 adsorbers.
the means for regulating a flow rate are selected from pneumatic, hydraulic or electric valves.
said purification unit is selected from PSA H2, PSA or VSA CO2, PSA or VSA O2, and PSA N2.

This invention also has for object an adsorption purification method implementing a purification unit according to the invention, and wherein each adsorber follows a pressure cycle less than 60 seconds, preferably less than 20 seconds and more preferentially less than 10 seconds.

According to the case, the method according to the invention can have one or several of the following features:
each means for regulating a flow rate is manoeuvred at most 2 times per pressure cycle;
each means for regulating a flow rate is manoeuvred according to the rotating speed of the rotary distributor;
the pressure cycle comprises a adsorption step, a step of pressure equalisation between the adsorbers, a step of supplying elution gas, a step of final decompression, a step of elution and a step of repressurisation; with the steps of supplying elution gas, elution and repressurisation having a flow exchange that is regulated via the means for regulating a flow rate;
each means for regulating a flow rate is manoeuvred when the flow coming from the rotary distributor or received by the rotary distributor has a decrease in the flow rate greater than 30%.

The invention shall now be described in more detail.

It begins with the observation that for most cycles, in order to re-establish an optimum cycle, it is sufficient to limit the flow rate during a limited number of steps, often over 2 steps only, that of the supply of elution gas and that of repressurisation while the cycles and in particular those with the most performance can comprise a large number of steps or phases.

It can further be observed that these two steps are not neighbouring and are preceded by an equalisation step for which time is available (these steps are completed at reduced operation before the end of the corresponding phase). It is therefore possible to manoeuvre valves during a portion of the preceding step in order to bring them to their optimum point of opening. The full opening can be accomplished rapidly, with the closing system then stopping against a suitable part.

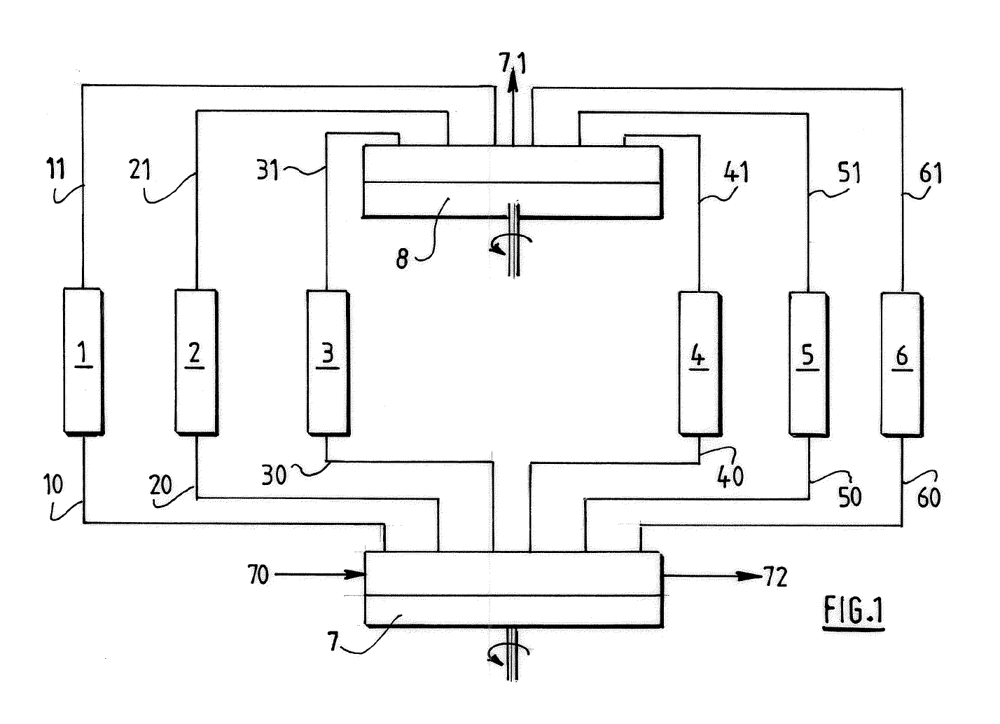

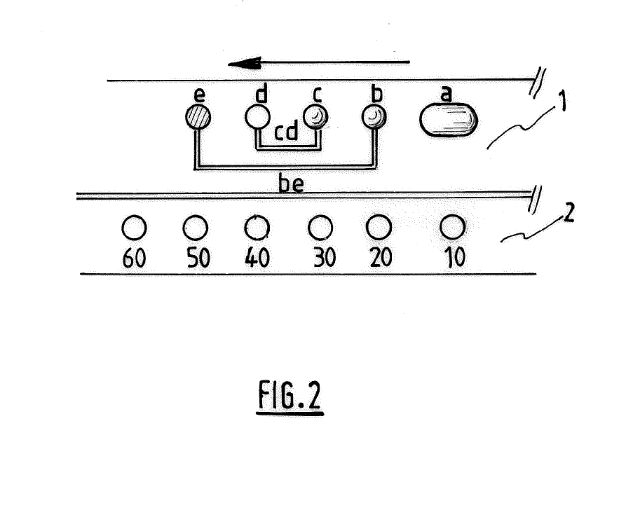

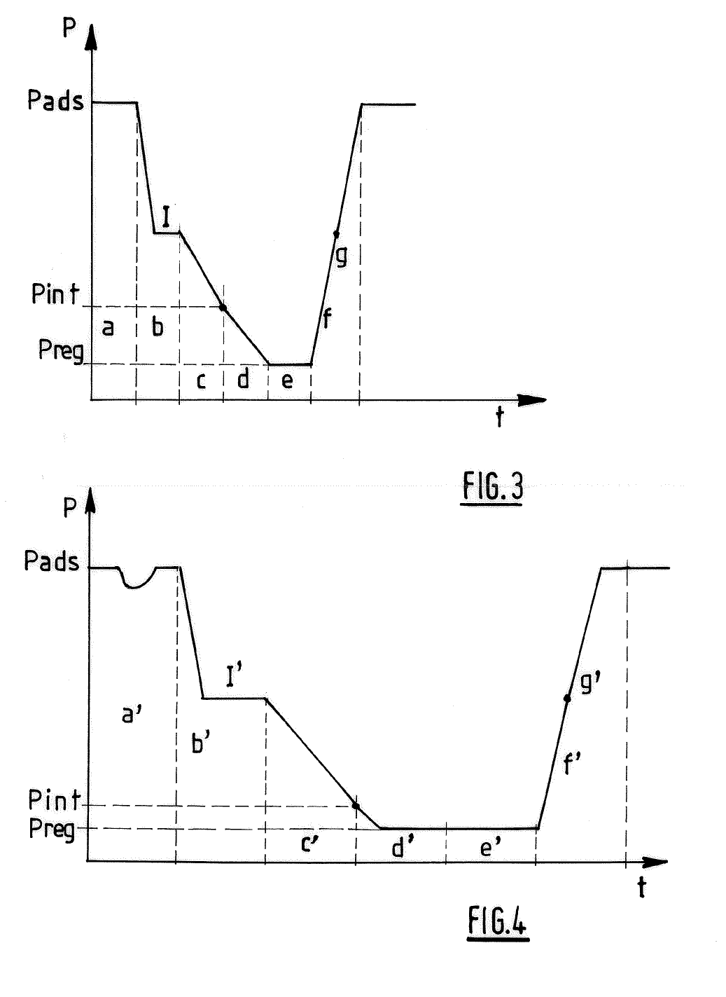

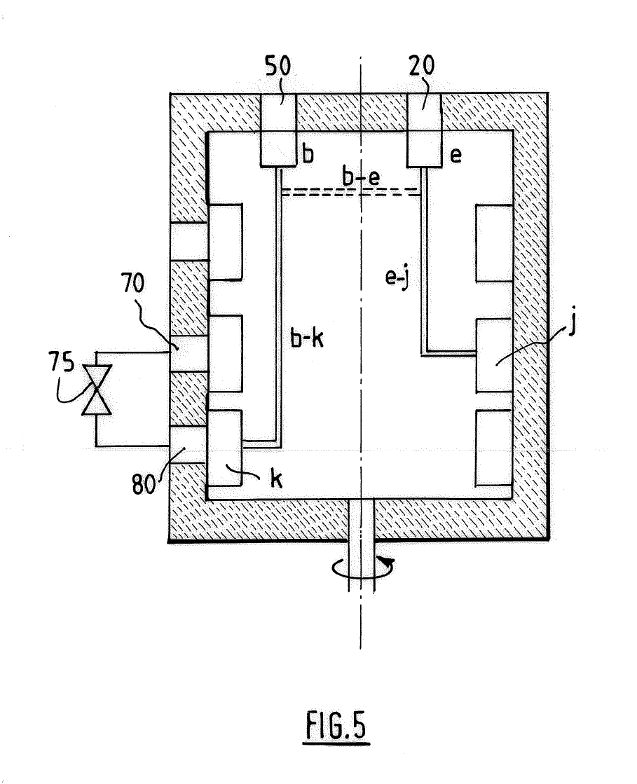

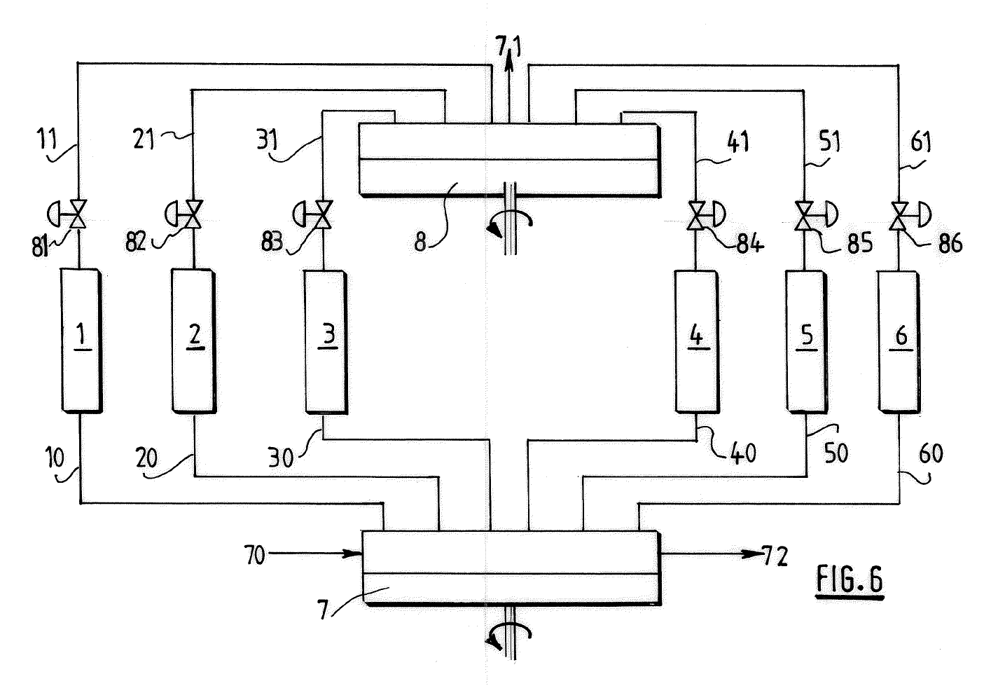

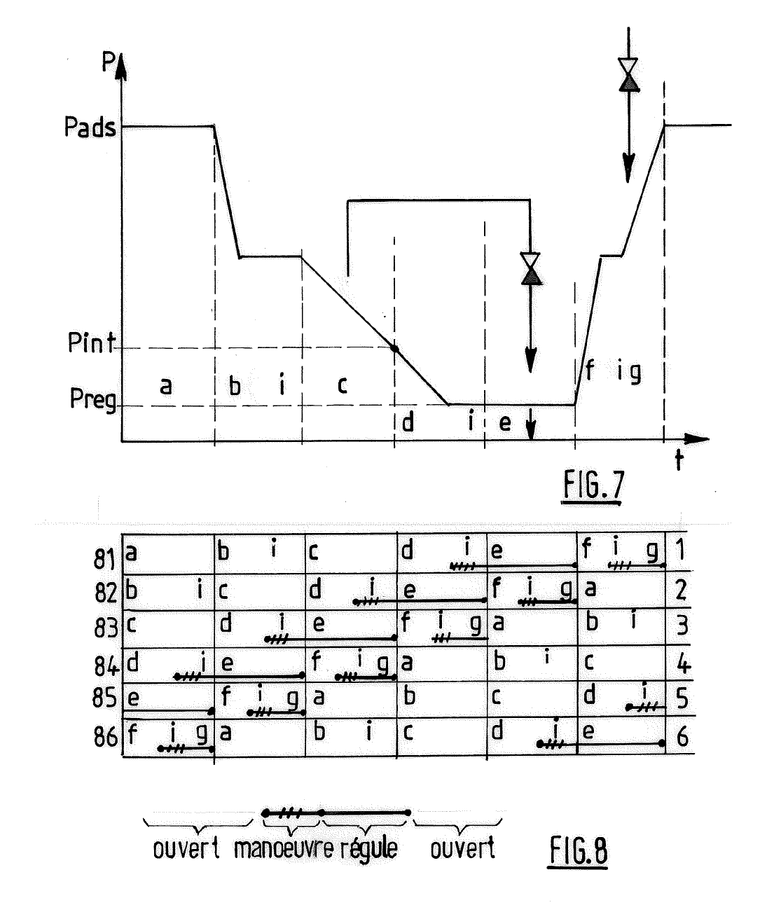

FIG. 6 shows an RPSA unit with 6 adsorbers and 2 rotary distributors similar to that of FIG. 1 except for the series of valves 81 to 86 placed on each of the connections 11 to 61 going from the outlet of the adsorber (production side) to the rotary distributor 71 production side.

FIG. 7 then shows the cycle that can be obtained with the system described hereinabove.

Still with the hypothesis that only 50% of the supply gas is treated and in order to accomplish this, the speed of the rotary distributors is slowed by a factor of 2, as a first approach.

50% of the standard supply flow rate is introduced during the double amount of time. The same quantity of gas is therefore purified during the production phase. The equalisation which depends solely on the relative pressures of the 2 adsorbers and of the connection circuit is accomplished approximately in the same time as for the nominal flow rate. Note in practice that according to the change over time of the actual opening obtained through the passage of the orifice of the rotor on that of the rotor, there may be a small difference but which does not change the interpretation of the invention in any way.

It is desired to control the step of supplying elution gas. This can be done in several ways: by limiting the flow rate at the outlet of the adsorber which provides the gas, at the inlet of the adsorber which receives the gas or by intervening on both of the valves.

It was selected here to show the case where controlling of the flow rate is accomplished on the adsorber which receives. The best manner to proceed is to examine this on a case-by-case basis.

Having overcome the problem of the intermediate pressure, the final decompression lasts approximately the same time as in the nominal case. The end of the step therefore includes an idle time i which can be taken advantage of for bringing the means for regulating the flow rate of elution into its required position. As the step of elution has occurred in an optimum manner, the equalisation f takes place as planned. As it completes before the time allotted by the movement of the rotor, there is again another small amount of idle time between the equalisation and the repressurisation. This idle time is taken advantage of in order to manoeuvre the means for regulating to its new position corresponding to a regular repressurisation.

FIG. 8 shows the valve movements for the 6 adsorbers. They are deduced from one another via circular permutation.

It can be observed that there are only 2 movements required per cycle in order to fully optimise the method. In addition, a portion of a phase time is available each time in order to manoeuvre the valve (in the case of a valve) to its open position, which still makes it possible to use conventional or existing materials.

With the rotary distributors on the supply side and on the production side (i.e. the first and the second rotary distributor) operating in a synchronised manner, it is normal that they be mounted on a single axis driven by a single motor.

Preferably, this is a continuous rotation and as has been shown, the driving shall take place preferentially at a variable speed as soon as it is desired to have a first means for regulating.

This system is applied in particular to RPSAs, which means that in general the cycle time will be less than 60 seconds, which in this case in the case of the example corresponds to a phase time of 10 seconds.

For a faster RPSA, with a cycle time for example equal to 12 seconds, each phase will in this case be 2 seconds. It can be seen that it is possible to have times of about a second to bring a valve to its required position, which is in the range of what can be carried out even for large diameters (several hundred millimetres).

The number of adsorbers will vary according to the flow rate to be treated and the cycle retained. Most units will have between 2 and 30 adsorbers but groups of adsorbers in parallel that multiply this number of adsorbers by a factor of 2 to 3 can be considered.

More preferably, about 6 to 20 adsorbers will be used in order to have a simple system.

In light of the rapidity of the cycle under consideration, the adsorbers will generally be contactors. Contactor means an adsorber comprising structured adsorbents (for example, the adsorbent is deposited as a thin layer on the two sides of a support which is then rolled). Various types of spacers are used to maintain a regular passage for the gas.

The additional means for regulating added to at least one of the rotary distributor connections on the supply/adsorber inlet side or adsorber outlet (production side)/rotary distributor production side can be of any type that is able to provide for the control of the flow rate in said connection. Generally, this will be a restriction, more or less local, of the section of the passage. The most common means are valves, of any type, but varied closures can be considered. These means can be manoeuvred in different ways: pneumatic, hydraulic, electric, magnetic.

It can be interesting to couple the movement of the valves with the position (angle of rotation for example) of one of the distributors, or of the motor or of the axis of rotation. The indication of the position can be accomplished via any method (optical, mechanical, electrical, magnetic, etc.).

As the rotation speed imposes the cycle, it will be advantageous to connect the opening value of the means for regulating to the rotation speed. This connection can be made directly or go through any control system.

These means for regulating will preferentially be used at a reduced speed for distributors but they can also be used at the nominal point as a means for optimising the pressure cycle.

When stopped, they can be used as a means for isolating the adsorber, in particular on the supply side where the gas can contain impurities that it is not desirable to leave in contact with the adsorber.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-11. (canceled)

12. A pressure swing adsorption purification unit comprising:
N adsorbers comprising N inlets and N outlets with N≧2;
at least one first rotary distributor connected via N first connections to the N inlets of the N adsorbers;
at least one second rotary distributor connected via N second connections to the N outlets of the N adsorbers;
each of the N first connections and/or of the N second connections comprising a means for regulating a flow rate; and the first rotary distributor and the second rotary distributor being mounted on the same axis.

13. The pressure swing adsorption purification unit of claim 12, wherein at least one rotary distributor is a distributor with continuous or discontinuous rotation.

14. The pressure swing adsorption purification unit of claims 12, wherein at least one rotary distributor is with variable speed.

15. The pressure swing adsorption purification unit of claim 12, wherein said unit comprises from 2 to 30 adsorbers.

16. The pressure swing adsorption purification unit of claim 15, wherein said unit comprises from 6 to 20 adsorbers.

17. The pressure swing adsorption purification unit of claim 16, wherein the means for regulating are selected from pneumatic, hydraulic or electric valves.

18. The pressure swing adsorption purification unit of claim 12, wherein said purification unit is selected from the group consisting of PSA H2, PSA or VSA CO2, PSA or VSA O2, and PSA N2.

19. The pressure swing adsorption purification unit of claim 12, wherein each adsorber follows a pressure cycle of less than 60 seconds,

20. The pressure swing adsorption purification unit of claim 19, wherein each adsorber follows a pressure cycle of less than 20 seconds

21. The pressure swing adsorption purification unit of claim 19, wherein each adsorber follows a pressure cycle of less than 10 seconds.

22. The pressure swing adsorption purification unit of claim 12, wherein each means for regulating a flow rate is manoeuvred at most 2 times per pressure cycle.

23. The pressure swing adsorption purification unit of claim 12, wherein each means for regulating a flow rate is manoeuvred according to the rotation speed of the rotary distributor.

24. The pressure swing adsorption purification unit of claim 12, wherein the pressure cycle comprises a adsorption step, a step of pressure equalisation between the adsorbers, a step of supplying elution gas, a step of final decompression, a step of elution and a step of repressurisation; with the steps of supplying elution gas, elution and repressurisation having a flow exchange that is regulated via the means for regulating a flow rate.

25. The pressure swing adsorption purification unit of claim 12, wherein each means for regulating a flow rate is manoeuvred when the flow coming from the rotary distributor or received by the rotary distributor has a decrease in the flow rate greater than 30%.
